(19) United States
(12) Patent Application Publication
(10) Pub. No.: US 2006/0052923 A1
(43) Pub. Date: Mar. 9, 2006

(54) Classification system and method using relative orientations of a vehicle occupant

(75) Inventors: Michael E. Farmer, W. Bloomfield, MI (US); Shweta R. Bapna, Rochester Hills, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Eaton Corporation (RJ), Cleveland, OH (US)

(21) Appl. No.: 10/934,620

(22) Filed: Sep. 3, 2004

(51) Int. Cl. B60R 21/32

(52) U.S. Cl. 701/45; 280/735; 180/271

(57) ABSTRACT

The present invention relates in general to systems and methods for classifying target information acquired with a sensor. In particular, the systems and methods relate to integrating relative orientations of the target information into evidential reasoning heuristics that are used to classify the target information. An exemplary system for classifying target information includes: an initial classification subsystem for determining an initial classification of the target information; a tracking subsystem for identifying a relative orientation of the target information in relation to a predefined reference; and a weighted classification determination subsystem for generating a classification of the target information based on said initial classification and said relative orientation.

### RELATED APPLICATIONS

The contents of the following patent applications are hereby incorporated by reference in their entirety: A RULES-BASED OCCUPANT CLASSIFICATION SYSTEM FOR AIRBAG DEPLOYMENT,Ser. No. 09/870,151, filed on May 30, 2001; IMAGE PROCESSING SYSTEM FOR DYNAMIC SUPPRESSION OF AIRBAGS USING MULTIPLE MODEL LIKELIHOODS TO INFER THREE DIMENSIONAL INFORMATION, Ser. No. 09/901,805, filed on Jul. 10, 2001; IMAGE PROCESSING SYSTEM FOR ESTIMATING THE ENERGY TRANSFER OF AN OCCUPANT INTO AN AIRBAG, Ser. No. 10/006,564, filed on Nov. 5, 2001; IMAGE SEGMENTATION SYSTEM AND METHOD, Ser. No. 10/023,787, filed on Dec. 17, 2001; and IMAGE PROCESSING SYSTEM FOR DETERMINING WHEN AN AIRBAG SHOULD BE DEPLOYED, Ser. No. 10/052,152, filed on Jan. 17, 2002; MOTION-BASED IMAGE SEGMENTOR FOR OCCUPANT TRACKING, Ser. No. 10/269.237, filed on Oct. 11, 2002; OCCUPANT LABELING FOR AIRBAG-RELATED APPLICATIONS, Ser. No. 10/269,308, filed on Oct. 11, 2002; MOTION-BASED IMAGE SEGMENTOR FOR OCCUPANT TRACKING USING A HAUSDORF-DISTANCE HEURISTIC, Ser. No. 10/269,357, filed on Oct. 11, 2002; SYSTEM OR METHOD FOR SELECTING CLASSIFIER ATTRIBUTE TYPES, Ser. No. 10/375,946, filed on Feb. 28, 2003; SYSTEM AND METHOD FOR CONFIGURING AN IMAGING TOOL, Ser. No. 10/457,625, filed on Jun. 9, 2003; SYSTEM OR METHOD FOR SEGMENTING IMAGES, Ser. No. 10/619,035, filed on Jul. 14, 2003; SYSTEM OR METHOD FOR CLASSIFYING IMAGES, Ser. No. 10/625,208, filed on Jul. 23, 2003; SYSTEM OR METHOD FOR IDENTIFYING A REGION-OF-INTEREST IN AN IMAGE, Ser. No. 10/663,521, filed on Sep. 16, 2003; DECISION ENHANCEMENT SYSTEM FOR A VEHICLE SAFETY RESTRAINT APPLICATION, Ser. No. 10/703,345, filed on Nov. 7, 2003; DECISION ENHANCEMENT SYSTEM FOR A VEHICLE SAFETY RESTRAINT APPLICATION, Ser. No. 10/703,957, filed on Nov. 7, 2003; METHOD AND SYSTEM FOR CALIBRATING A SENSOR, Ser. No. 10/662,653, filed on Sep. 15, 2003; and SYSTEM OR METHOD FOR CLASSIFYING TARGET INFORMATION CAPTURED BY A SENSOR, Ser. No. 10/776,072, filed on Feb. 11, 2004.

### BACKGROUND OF THE INVENTION

The present invention relates in general to systems and methods for classifying target information acquired with a sensor. In particular, the systems and methods relate to integrating relative orientations of the target information into evidential reasoning heuristics that are used to classify the target information.

Although automated sensor systems have many advantages over human beings in terms of capturing information and images, human beings maintain a remarkable superiority in classifying and interpreting information. For example, if a person views video footage of a human being pulling off a sweater over his or her head, the viewer will not doubt the continued existence of the human being's head simply because the head is temporarily covered by the sweater. In contrast, an automated system in the same circumstance may have great difficulty in determining whether a human being is within the image due to the absence of a visible head. In the analogy of not seeing the forest for the trees, automated systems are excellent at capturing detailed information about various trees in the forest, but human beings are much better at classifying the area as a forest. Moreover, human beings better integrate current data with past data, and better realize the inherent limits of the powers of observation in a particular context. For example, a human being may consider that he or she did not have a particularly good view of the target of the sensor.

Preexisting classification systems suffer from a lack of awareness that a particular target captured by the sensor may be in a poor position for providing a confident classification. In the context of an occupant classification system used with an automated vehicle safety restraint application, a vehicle occupant may frequently move within the vehicle. It is of particular concern that the vehicle occupant may assume positions that tend to lead typical classification systems to unknowingly render uncertain and even erroneous occupant classifications. For example, when an adult occupant leans too far forward in the car seat, conventional classification systems may incorrectly classify the occupant as a rear-facing infant seat (RFIS).

A number of preexisting classification systems make use of evidential reasoning algorithms and historical classification data to enhance their classification capabilities. These systems use previous classifications to help determine the reliability of a potential current classification. However, if the historical data includes uncertainty or error, the classification system nevertheless risks making an incorrect or unreliable current classification. Typical classification systems may unknowingly base a current classification decision on previous classifications obtained from unreliable data. For example, the fact that a previous classification was based on an unfavorable or unreliable sensor reading may be easily overlooked by conventional classification systems.

It is therefore desirable to improve the accuracy and/or the awareness of classification systems by accounting for levels of uncertainty associated with classification determinations, including improving the awareness of the levels of reliability associated with previous classifications used to generate a current classification.

### SUMMARY OF THE INVENTION

The present invention relates in general to systems and methods (collectively “classification system,” “classifier,” or simply “the system”) for classifying target information acquired with a sensor. In particular, the systems and methods relate to integrating relative orientations of the target information into evidential reasoning heuristics that are used to classify the target information.

An exemplary system according to the invention for classifying target information includes: an initial classification subsystem for determining an initial classification of the target information; a tracking subsystem for identifying a relative orientation of the target information in relation to a predefined reference; and a weighted classification determination subsystem for generating a weighted classification of the target information based on the initial classification and the relative orientation.

Another exemplary system according to the invention can classify a vehicle occupant in a vehicle safety restraint application. The system includes a sensor configured to acquire a target image representative of the vehicle occupant in the vehicle safety restraint application and a computer configured to: generate an initial classification of the target information; track the target image to identify a relative orientation of the vehicle occupant in relation to a predefined reference; generate a weighted classification of the vehicle occupant using an evidential reasoning heuristic, wherein the weighted classification is based on the initial classification and the relative orientation; and provide the vehicle safety restraint application with the weighted classification.

An exemplary method according to the invention for using a visual image acquired by a sensor to classify a vehicle occupant in a vehicle safety restraint application includes: generating an initial classification of the vehicle occupant; identifying a relative orientation of the vehicle occupant in relation to a predefined reference; and generating a weighted classification of the vehicle occupant based on the initial classification and the relative orientation.

Another exemplary method according to the invention includes steps for implementing an occupant classifier for use in a vehicle safety restraint application, including: configuring a tracker to use a visual image to identify a relative orientation of the occupant in relation to a predefined reference; implementing a weighted classification heuristic configured to generate a weighted classification of the vehicle occupant based on historical classification attributes that are configured to be influenced by the relative orientation and an initial classification of the vehicle occupant; defining a group as a disablement decision; and configuring the vehicle safety restraint application to preclude deployment of a safety restraint device when the weighted classification indicates that the vehicle occupant is classified as the group.

Various aspects of this invention will become apparent to those skilled in the art from the following detailed description of the preferred embodiment, when read in light of the accompanying drawings.

Throughout the drawings, identical reference numbers designate identical or similar elements.

### BRIEF DESCRIPTION OF THE DRAWINGS

FIG. 1 is a partial schematic view illustrating an example of a classification system implemented in a vehicle safety restraint application environment.

FIG. 2 is a high-level process flow diagram further illustrating the classification system of FIG. 1.

FIG. 3 is a subsystem-level view of the classification system of FIGS. 1 and 2, showing an example of a safety restraint deployment application utilizing the classification system.

FIG. 4 is a representation of target information identified by a bounding ellipse.

FIG. 5A shows exemplary bounding ellipses at different relative orientations.

FIG. 5B shows exemplary zones of relative orientations in a forward-aft plane.

FIG. 6A is an example of an acquired image having bounding ellipses located at reliable relative orientations.

FIG. 6B is an example of an acquired image having bounding ellipses located at forward-leaning relative orientations.

FIG. 6C is an example of an acquired image having bounding ellipses located at rearward-leaning relative orientations.

FIG. 7 is an input/output diagram illustrating an embodiment of the determination subsystem of FIG. 3.

FIG. 8A shows an example of a rear-facing infant seat (RFIS) occupant in a vehicle safety restraint application embodiment of the classification system.

FIG. 8B shows an example of a child-class occupant in a vehicle safety restraint application embodiment of the classification system.

FIG. 8C shows an example of an adult occupant in a vehicle safety restraint application embodiment of the classification system.

FIG. 8D shows an example of an empty seat in a vehicle safety restraint application embodiment of the classification system.

FIG. 9A shows an adult occupant at a generally upright position in a vehicle.

FIG. 9B shows an adult occupant at a forward-leaning position in a vehicle.

FIG. 10 is a flow diagram illustrating a detailed example of a classification process in a vehicle safety restraint application embodiment.

FIG. 11 is a flow diagram illustrating an exemplary process for implementing an occupant classifier for use in a vehicle safety restraint application.

### DETAILED DESCRIPTION OF A PREFERRED EMBODIMENT

The present invention relates in general to systems and methods (collectively “classification system,” “classifier,” or simply “the system”) for classifying target information acquired with a sensor. In particular, the systems and methods relate to integrating relative orientations of the target information into evidential reasoning heuristics that are used to classify the target information. The systems and methods may dynamically integrate relative orientations of the target information into historical classification data that can be used to classify the target information. For example, the systems and methods can generate accurate and reliable weighted classifications of the target information based on tracked relative orientations and initial classifications of the target information. The weighted classifications may be used by the methods and systems to reflect an awareness of levels of reliability associated with the target information.

Throughout the specification and the claims, “relative orientation” should be understood to indicate a position or orientation of the target information in relation to its environment. For example, relative orientation can describe the positional relation of the target information to an object or area within the same environment. Alternatively, relative orientation can describe a positional relation of the target information to a predefined object, such as a reference point or line. In the context of a vehicle safety restraint application embodiment, relative orientation can include an orientation or position of a vehicle occupant in relation to the vehicle environment or in relation to an object or predefined reference associated with the vehicle environment. Relative orientation may be determined or measured in a number of different ways that will be discussed below.

The relative orientation of the target information is used to help classify the target information. As mentioned above, weighted classifications of the target information can be generated using evidential reasoning heuristics that take the initial classifications and relative orientations of the target information into account. Throughout the specification and the claims, “evidential reasoning heuristic” is meant to be understood broadly as any algorithmic or mathematical process that generates a weighted classification or a confidence factor for a classification based on degrees of probabilities and uncertainties. The evidential reasoning heuristics should incorporate the relative orientations of the target information into determinations of the weighted classifications of target information. Preferably, the evidential reasoning heuristics use historical classification data to determine the weighted classifications of the target information. The historical classification data may include the relative orientation of the target information. In a preferred embodiment, the evidential reasoning heuristics are based on the Dempster-Shafer Theory of Evidence, which will be discussed in detail below.

I. Partial View of Surrounding Enviroment

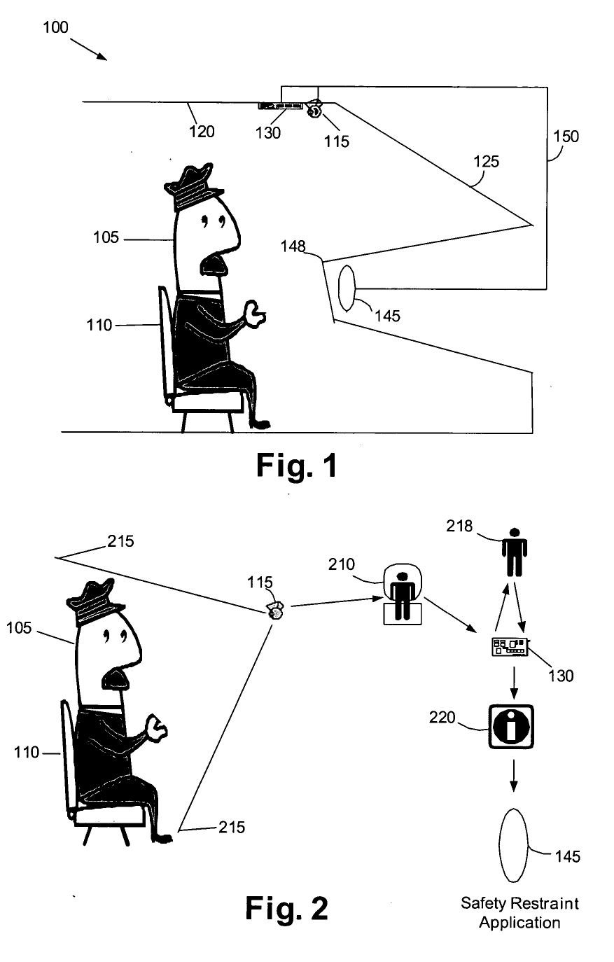

Referring now to the drawings, FIG. 1 is a partial view illustrating an example of a classification system 100 (also referred to as “classifier 100,” or “the system 100”) implemented in a vehicle safety restraint application environment. If an occupant 105 is present, the occupant 105 can sit on a seat 110. A video camera or any other sensor capable of rapidly capturing images (collectively “sensor” 115) can be attached at an appropriate position for capturing images having target information illustrative of the position of the occupant 105. For example, the sensor 115 may be positioned in a roof liner 120, above the occupant 105 and closer to a front windshield 125 than the occupant 105. The sensor 115 can be placed at a slightly downward angle towards the occupant 105 in order to capture changes in the angle of the occupant's 105 upper torso resulting from forward or backward movement in the seat 110. There are many potential locations for the sensor 115 that are known in the art.

A wide range of different sensors 115 can be used by the system 100 to acquire images tending to illustrate the position of the occupant 105 relative to the vehicle. For example, the sensor 115 may comprise a standard video camera that typically captures approximately forty frames of images per second. Higher and lower speed sensors 115 can be used by the system 100. The sensor 115 can also refer to a number of sensors 115, such as multiple video cameras, or even multiple sensors of different types.

Further, particular sensors 115 can be configured to acquire various forms of input other than visual images. A particular sensor 115 can detect an event or status of the vehicle or the safety restraint application 145. Thus, sensors 115 can be configured to detect statuses such as whether a door of a vehicle is open, whether the vehicle is stopped, whether the occupant is restrained by a seatbelt, whether the brakes are being applied, etc. In some embodiments, the sensor 115 can gather input and convert the input into a visual representation.

A computer system 130 (also referred to as “computer 130”) is potentially any type of processor or other device (such as an embedded computer, programmable logic device, or general purpose computer) that is capable of performing the various processes helpful for the classification system 100 to receive, track, and classify various inputs. In some embodiments of the system 100, there may be a combination of processors or other devices that perform these functionalities. The programming logic and other forms of processing instructions performed by the computer 130 are typically implemented in the form of software, although they may also be implemented in the form of hardware, or even in a combination of software and hardware mechanisms. The computer 130 can be located virtually anywhere in or on a vehicle. Preferably, the computer 130 is located near the sensor 115 to avoid sending images through long wires.

As shown in FIG. 1, a safety restraint application 145 can be located in a dashboard 148. However, it is anticipated that the system 100 can function with safety restraint applications 145 positioned at alternative locations, such as in a vehicle door panel. The safety restraint application 145 may comprise an airbag deployment mechanism.

The safety restraint application 145 should be configured to make safety restraint deployment decisions based on classifications rendered by the classification system 100. For example, the safety restraint application 145 may disable, enable, or adjust the deployment characteristics of a safety restraint device based, at least in part, on the rendered classifications. The system 100 can be flexibly implemented to incorporate future changes in the design of vehicles and safety restraint applications 145.

As shown in FIG. 1, a communications network 150 can provide for communications between the sensor 115, the computer 130, and the safety restraint application 145. The communication network 150 may comprise any components helpful for facilitating electronic communications, including wireless and/or wire-line communications.

II. High-Level Process Flow for Safety Restraint Deployment

FIG. 2 shows a high-level process flow diagram illustrating an example of the classification system 100 in the context of the vehicle safety restraint application 145 of FIG. 1. The sensor 115 can capture a target image 210 (also referred to as “visual image 210) representative of a target area 215. The target area 215 can include both the occupant 105 and surrounding seat area. In FIG. 2, the target area 215 includes the entire occupant 105, although under many different circumstances and embodiments, only a portion of the occupant's 105 image will be captured, particularly if the sensor 115 is positioned in a location where the lower extremities may not be viewable.

The target image 210 can be made available to the computer 130 for processing. In particular, the computer 130 is able to identify target information 218 within the target image 210. The target information 218 can include any information related to a portion of the target image 210 that can be expected to have a motion associated with it. For example, in the context of a vehicle safety restraint application embodiment, the target information 218 can represent characteristics of the vehicle occupant 105, such as a position or motion of the occupant 105 in the vehicle.

In some embodiments, the target information 218 can include attribute vectors, which are discussed in detail in the following patent applications, which are hereby incorporated by reference in their entirety: “A RULES-BASED OCCUPANT CLASSIFICATION SYSTEM FOR AIRBAG DEPLOYMENT,” Ser. No. 09/870,151, filed on May 30, 2001; “OCCUPANT LABELING FOR AIRBAG-RELATED APPLICATIONS,” Ser. No. 10/269,308, filed on Oct. 11, 2002 “SYSTEM OR METHOD FOR SELECTING CLASSIFIER ATTRIBUTE TYPES,” Ser. No. 10/375,946, filed on Feb. 28, 2003; and “SYSTEM OR METHOD FOR CLASSIFYING IMAGES,” Ser. No. 10/625,208, filed on Jul. 23, 2003.

The computer 130 can be configured to generate an initial classification of the target information 218. The generation of the initial classification in discussed below.

The computer 130 can be configured to generate a weighted classification 220 (also referred to as “current classification 220” or simply “classification 220”) of the target information 218. The weighted classification 220 is potentially any determination made by the classification system 100 that is based at least in part on the initial classification and a relative orientation of the target information 218. Weighted classifications 220 can be in the form of numerical values or in the form of categorical values believed to categorize the target information 218. In a safety restraint application embodiment of the system 100, the classification 220 can include a categorization of the vehicle occupant 105.

As mentioned above, the weighted classification 220 of the target information 218 is based, at least in part, on the relative orientation of the target information 218. The computer 130 can track the target information 218 to identify the relative orientation and position of the target information 218. The relative orientation and position can then be used by the system 100 to help determine the weighted classification 220 of the target information 218. In a preferred embodiment, the relative orientation is integrated into historical classification data that will be used to help determine the classification 220. The processes by which the computer 130 integrates relative orientations into historical data to classify the target information 218 will be described in greater detail below.

The safety restraint application 145 can use the weighted classification 220 to help make an appropriate safety restraint deployment decision. For example, the safety restraint application 145 can disable deployment of a safety restraint when the occupant 105 is classified as a rear-facing infant seat (RFIS). If the occupant 105 is classified as an adult, the safety restraint application 145 can dynamically track the occupant 105 and use the track information to make deployment decisions, based at least in part on whether the occupant 105 appears to be too close to the safety restraint mechanism (e.g. an airbag) for a safe deployment. Various techniques for using occupant 105 classifications to help make safety restraint deployment and suppression decisions are described in some of the patent applications that have been incorporated by reference in their entirety.

III. Subsystem-Level View

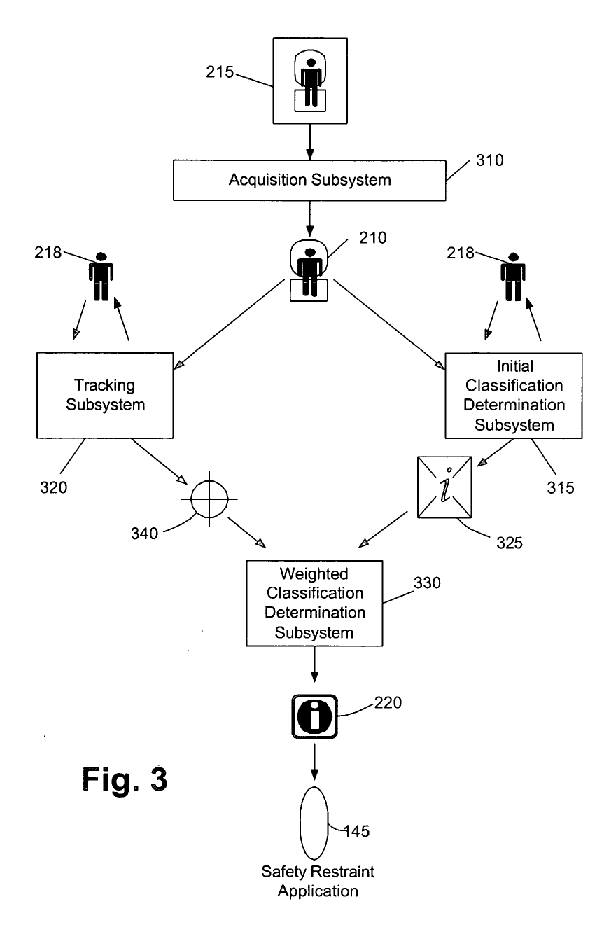

FIG. 3 illustrates a subsystem-level view of an exemplary classification system 100 implemented in a safety restraint application embodiment. The process shown in FIG. 3 can be configured to repeat for generating classifications 220 for any number of target images 210 in a sequence. For example, the process may continuously repeat for each consecutive image frame 210 when certain predetermined conditions are satisfied. The predetermined conditions can include but are not limited to any number or combination of the following conditions: the occupant 105 is in the vehicle; a vehicle door is closed; the vehicle is stopped; and the vehicle is operating.

A. Acquisition Subsystem

As shown in FIG. 3, the target image 210 representative of the target area 215 can be acquired by an acquisition subsystem 310. Preferably, the acquisition subsystem 310 is configured to acquire successive target images 210. The acquisition subsystem 310 may include the sensor 115 described above for capturing the target images 210.

The acquisition subsystem 310 can perform pre-processing routines on the information acquired by the sensor 115. For example, the acquisition subsystem 310 may convert acquired data into a different format, including preparing raw data for subsequent processing. In a preferred embodiment, the acquisition subsystem 310 captures data in a visual format, such as raw raster data. In alternative embodiments, the acquisition subsystem 310 may acquire data in non-visual formats and convert the data into a visual-based format. In any event, the acquisition subsystem 310 can provide the target image 210 for processing by other subsystems, namely an initial classification determination subsystem 315 and a tracking subsystem 320, which are described below.

B. Initial Classification Determination Subsystem

The initial classification determination subsystem 315 can process the target image 210 to identify the target information 218 that is to be classified. The identification processes can employ any of the segmentation techniques disclosed in the patent applications that have been incorporated by reference in their entirety.

The initial classification determination subsystem 315 can then generate an initial classification 325 of the identified target information 218 by employing any of the occupant classification processes or techniques disclosed in the patent applications that have been incorporated by reference in their entirety. The initial classification 325 can include rear-facing infant seat (RFIS), child, adult, empty, etc. In a preferred embodiment, the initial classification determination subsystem 315 implements the occupant classification techniques described in the U.S. Patent Application titled “SYSTEM OR METHOD FOR CLASSIFYING IMAGES,” Ser. No. 10/625,208, filed on Jul. 23, 2003, to determine the initial classification 325 of the target information 218.

The initial classification 325 is made available to a weighted classification determination subsystem 330, which will be discussed in detail below. In a preferred embodiment, an initial classification 325 is determined approximately every 3-5 seconds.

C. Tracking Subsystem

As shown in FIG. 3, the acquisition subsystem 315 can make the target image 210 available to the tracking subsystem 320. The tracking subsystem 320 (also referred to as “tracker 320” or “dynamic tracker 320”) can process the target image 210 to identify the target information 218 that is to be tracked as discussed below. To identify the target information 218, the tracking subsystem 320 may implement any of the exemplary segmentation techniques described in the patent applications that have been incorporated by reference in their entirety and that are suitable for real-time video segmentation.

In a preferred embodiment, the tracking subsystem 315 employs a shape-fitting process to help identify the target information 218. For example, the tracking subsystem 315 can fit an elliptical shape to an area of interest, i.e., the target information 218, within the target image 210. The tracking subsystem 315 may determine parameters defining an ellipse that identifies the target information 218. To fit an elliptical shape to the target information 218, the tracking subsystem 315 can implement any of the exemplary ellipse-fitting techniques described in the patent applications that have been incorporated by reference in their entirety.

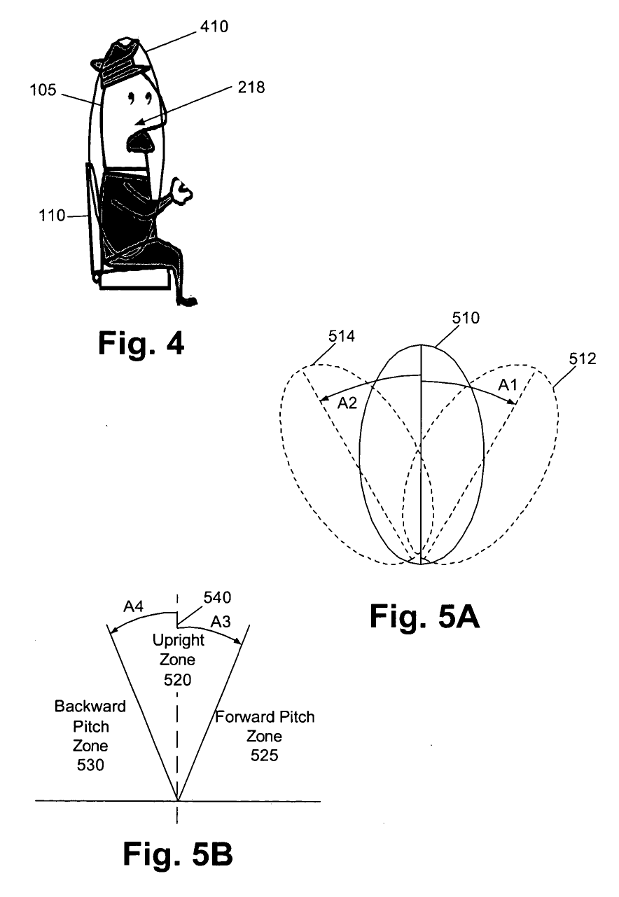

FIG. 4 shows an example of target information 218 (e.g., the occupant 105) identified by a bounding ellipse 410 in the context of a safety restraint application embodiment. As shown in FIG. 4, the bounding ellipse 410 can be fitted generally to the upper torso and head area of the vehicle occupant 105. This general area of the occupant 105 is helpful for determining a relative orientation or position of the occupant 105 in the vehicle.

Returning now to FIG. 3, the tracking subsystem 320 can be configured to determine a relative orientation 340 (also referred to as “relative position 340”) of the target information 218. As mentioned above, relative orientation 340 indicates a position or orientation of the target information 218 in relation to its environment. For example, relative orientation 340 can describe a positional relation of the target information 218 to an object or area within the same environment. Alternatively, relative position 340 can describe a positional relation of the target information 218 to a predefined reference, such as a reference line.

In the context of a vehicle safety restraint application embodiment, relative orientation 340 may be defined as an orientation or position of the occupant 105 in relation to the environment of occupant 105, which environment can include but is not limited to the vehicle, a defined safety restraint deployment zone or device, and another object in the vehicle environment. In some embodiments, relative orientation 340 describes a relational position of only a portion of the occupant 105. In a preferred embodiment, relative orientation 340 is indicated as an angular pitch/orientation of the occupant 105 in a generally forward-aft plane.

Relative orientation 340 can be identified in relation to a predefined reference. In a preferred embodiment, the predefined reference is a generally vertical axis representative of a generally upright position of the occupant 105. A generally upright orientation is a useful reference because generally upright positions of the occupant 105 tend to produce generally reliable classifications 220.

The tracking subsystem 320 can use the bounding ellipse 410 to determine the relative orientation 340 of the target information 218. When the bounding ellipse 410 is used to identify the target information 218, the tracking subsystem 320 accesses and tracks the parameters of the bounding ellipse 410 to determine the relative orientation 340 of the target information 218 in relation to the predefined reference. The major axis, minor axis, angular orientation, and/or other defining parameters of the bounding ellipse 410 can be used to identify its relative orientation 340.

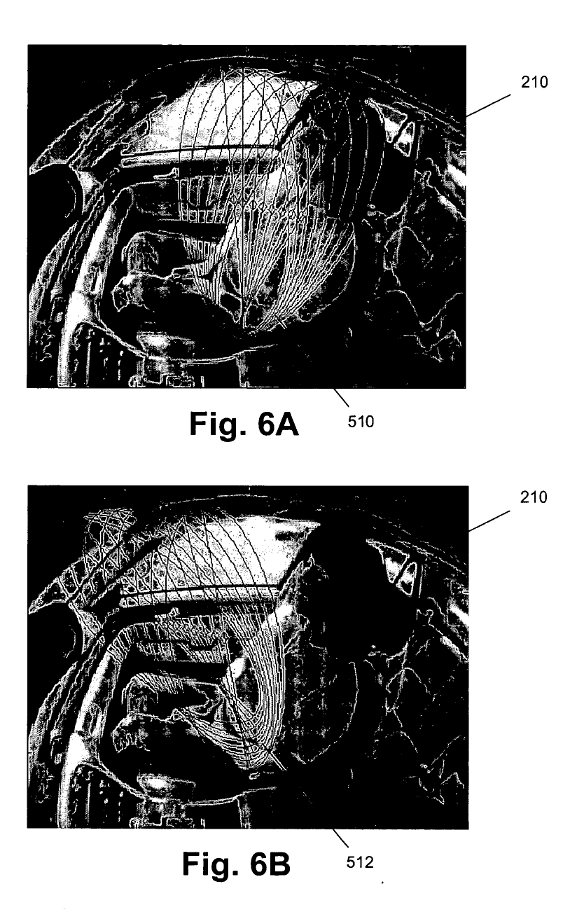

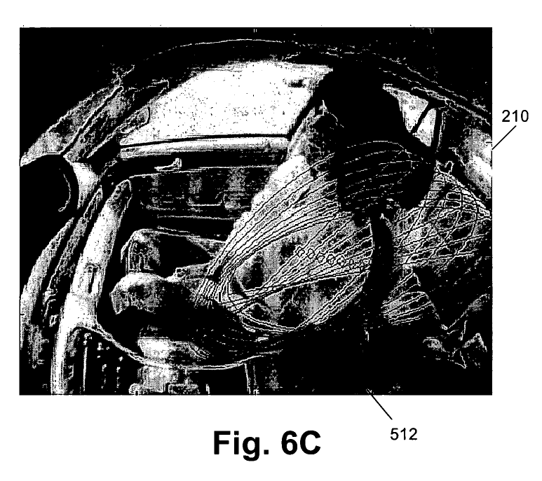

FIG. 5A shows bounding ellipses 510, 512, 514 at different relative orientations 340. The bounding ellipse 510 is at a generally upright position. This represents the occupant 105 positioned generally upright in the seat 110. FIG. 6A shows a particular target image 210 having a number of bounding ellipses 510 at generally upright positions. In generally upright orientations, the bounding ellipse 510 generally provides reliable data for use in classifying the occupant 105.

The bounding ellipse 512 as shown in FIG. 5A is in a generally forward-leaning position. This forward-pitch position can represent the occupant 105 leaning forward toward the dashboard 148 of the vehicle. An angle A1 represents the degree of pitch relative to an upright position. The angle A1 can be determined from the parameters defining the bounding ellipse 512. When the angle A1 is greater than approximately a predetermined threshold, the bounding ellipse 512 is said to be in a generally forward-leaning zone rather than a generally upright zone. FIG. 6B shows a particular target image 210 having a number of bounding ellipses 512 at generally forward-leaning positions.

When the bounding ellipse 512 is at a generally forward leaning orientation, the incoming image 210 provides less reliable data for classifying the occupant 105. The reliability of computed classification data decreases as the bounding ellipses 512 lean farther forward. At some predetermined threshold, the bounding ellipse 512 is oriented so far forward that the incoming image 210 provides no reliable data for classifying the occupant 105.

The bounding ellipse 514 is shown in FIG. 5A at a generally reclining position. At this position, the bounding ellipse 514 may represent the occupant 105 reclining generally backward in the seat 110. An angle A2 represents the degree of rearward pitch relative to an upright position. The angle A2 can be determined from the parameters defining the bounding ellipse 514. When the angle A2 is greater than approximately a predetermined threshold, the bounding ellipse 514 is said to be in a generally rearward-leaning zone rather than a generally upright zone. FIG. 6C shows a particular target image 210 having a number of bounding ellipses 514 at generally reclined positions.

When the bounding ellipse 514 is at a generally rearward-leaning orientation, the incoming image 210 provides less reliable data for classifying the occupant 105. The reliability of computed classification data from the incoming image 210 decreases as the bounding ellipses 514 lean farther rearward. At some predetermined threshold, the bounding ellipse 514 is oriented so far rearward that the incoming image 210 provides no reliable data for classifying the occupant 105.

FIG. 5B shows exemplary zones of relative orientations 340 in the generally forward-aft plane. An upright zone 520 can be defined to include generally upright bounding ellipses 510. A forward-pitch zone 525 can be defined to include generally forward-leaning bounding ellipses 512. A rearward-pitch zone 530 can be defined to include generally backward-leaning bounding ellipses 514. The zones 520, 525, 530 can be delineated from one another at predefined angles A3, A4 of orientation. The angles A3, A4 can be defined according to a predefined reference 540. In a preferred embodiment, the predefined reference 540 is a generally vertical axis representative of a generally upright relative orientation 340 of the occupant 105.

The forward-pitch zone 525 and the rearward-pitch zone 530 can also be referred to as zones of unreliability because with the relative orientation 340 falls within these zones, the associated classification 220 becomes less reliable. As will be discussed in further detail below, the system 100 can be configured to degrade the reliability of a classification 220 when the relative orientation 340 of the target information 218 falls within the forward-pitch zone 525 or the rearward-pitch zone 530.

Preferably, the tracking subsystem 320 dynamically tracks the target information 218 to determine the relative orientations 340 of the occupant 105 within the vehicle. Over time, numerous relative orientations 340 are determined. In a preferred embodiment, at least approximately 30-40 relative orientations 340 are determined per second. This allows the system 100 to track and accumulate a sequence of multiple relative orientations 340 between each initial classification 325 so that a sequence of tracked relative orientations 340 can be used to help determine weighted classifications 220 of the target information 218. By using the tracked relative orientations to generate the weighted classification 220, the system 100 is able to generate classifications 220 that account for the reliability of the initial classifications 325.

D. Weighted Classification Determination Subsystem

As shown in FIG. 3, the relative orientation 340 and the initial classification 325 are made available to the weighted classification determination subsystem 330 by the tracking subsystem 320 and the initial classification determination subsystem 315 respectively. The weighted classification determination subsystem 330 can integrate the relative orientations 340 and the initial classifications 325 with historical classification data, which can be used in combination with the initial classifications 325 and relative orientations 340 to determine accurate and weighted current classifications 220 of the target information 218. The system 100 can provide these classifications 220 to the safety restraint application 145 to assist with the rendering of deployment decisions. Exemplary classification processes that incorporate the relative orientations 340 and initial classifications 325 into classification determinations will now be described in more detail.

IV. Classification Determination

The system 100 can implement a wide variety of processes and heuristics to determine the weighted classification 220 of the target information 218 (e.g., occupant 105) based on some combination of the initial classification 325, the relative orientation 340, and historical classification data (discussed in more detail below). By using historical classification data to assist in making a current classification 220 determination, the system 100 improves the probability of making an accurate determination, especially when the initial classification 325 information may be uncertain, imprecise, or inaccurate. Similarly, the system 100 uses the relative orientations 340 to improve the probability of making an accurate determination even when the initial classification 325 and/or the historical data may be unreliable.

The field of evidential reasoning is conducive to making estimations that may be based to varying degrees on uncertainty and ignorance. Therefore, the system 100 can implement many evidential reasoning heuristics to make classification decisions based on a sequence of historical classification data. As will be discussed below, in a preferred embodiment, the system 100 incorporates relative orientations 340 of the target information 218 into Dempster-Shafer theory algorithms to make classification decisions. The Dempster-Shafer Theory of Evidence is a mathematical tool for representing and combining measures of evidence that is particularly useful when information is incomplete or uncertain.

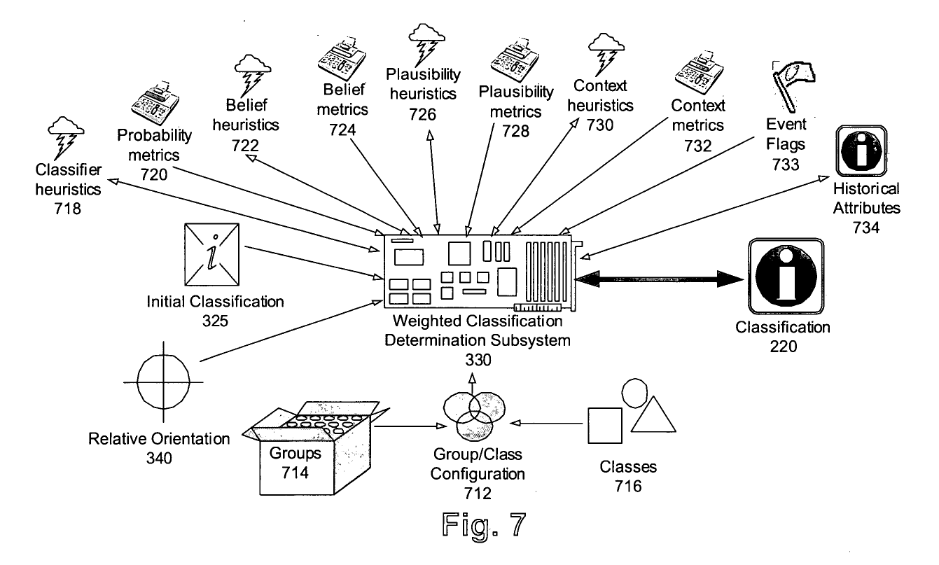

FIG. 7 is an input/output diagram illustrating one example of an embodiment of the weighted classification determination subsystem 330 that can implement evidential reasoning heuristics to make classification decisions. The primary output of the weighted classification determination subsystem 330 is the weighted classification 220 of the occupant 105. However, the occupant classification 220 can be used as an input for future classifications 220. Different embodiments of the weighted classification determination subsystem 330 can involve a wide variety of different types and numbers of inputs, including the initial classification 325 and the relative orientation 340. The inputs and outputs shown in FIG. 7 will now be discussed in more detail below.

A. Group/Class Configurations

The weighted classification determination subsystem 330 can use a wide variety of different group/class configurations 712. The group/class configuration 712 determines how many groups 714 are processed by the weighted classification determination subsystem 330, and the various classes 716 that are associated with those groups 714. The group/class configurations 712 are typically implemented in the data design that is incorporated into the functionality of the weighted classification determination subsystem 330. Such a design can be embodied in a data base, an array, flat files, or various other data structures and data design implementations.

In a preferred embodiment of the weighted classification determination subsystem 330, the selection of the appropriate classification 220 is made on the basis of the group 714 (group-level classification) instead of a classification 220 for a single specific class 716 (class-level classification). As discussed below, a single group 714 can include as few as one, and as many as all of the classes 716. By making classifications 220 at the level of group-identity rather than class-identity, the weighted classification determination subsystem 330 can be better equipped to deal with situations where two or more classes 716 have a relatively equal probability of being accurate or even a context where the second-best determination has a realistic probability of being accurate (collectively a “close call situation”). In a close call situation, the ability to set classifications 220 based on group-identity instead of class-identity eliminates the need to either: (1) give up and fail to provide a final classification determination of any type because there does not appear to be a single answer; or (2) arbitrarily choose one of the likely classes 716 despite the relatively high likelihood that one or more other classes 716 may be the true classification of the target information 218.

B. Classes

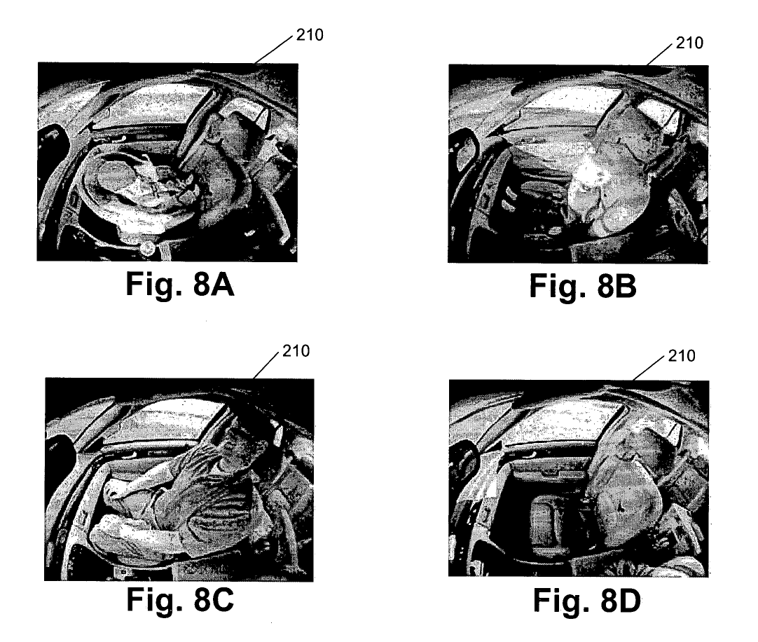

The class 116 represents the most granular and atomic characterization or categorization that can be made by the weighted classification determination subsystem 330. For example, in a preferred vehicle safety restraint embodiment of the system 100, the potential classes 716 will include that of an {adult, a child, a rear-facing infant seat (RFIS), and an empty seat}. In such an embodiment, the weighted classification determination subsystem 330 could classify one occupant 105 as being an adult, while another occupant 105 could be classified as a child. In alternative vehicle safety restraint embodiments, the library of potential classes 716 could also include a forward-facing child seat, a seat occupied by a box (or some other inanimate object), or any other myriad of potential classification distinctions. FIGS. 8A-D are target images 210 illustrative of classes 716 of RFIS, child, adult, and empty seat, respectively.

Regardless of the particular environment and embodiment, classes 716 should be defined (prior to the installation of the system 100) in light of the purposes of the application employing the use of the classification system 100. The classes 716 used by the system 100 in a particular embodiment should be defined in such a way as to capture meaningful distinctions such that the application using the system 100 can engage in the appropriate functionality on the basis of the information conveyed by the classification system 100.

In a preferred embodiment of the system 100 that utilizes the Dempster-Shafer theory of evidence, the list of potential classes 716 includes an exhaustive array of atomic and mutually exclusive objects. This list of all potential classes 716 can be referred to as the “environment.”

C. Groups

The group/class configurations 712 used by the weighted classification determination subsystem 330 can include a wide variety of different groups 714. Each group 714 is preferably made up of one or more classes 716. Some groups 714 may be made up of only one class 716, while one group 714 within a particular embodiment of the system 100 could be made up of all potential classes 716. Groups 714 can also be referred to as sets (a group 714 is a mathematical set of classes 716), and many implementations of the system 100 will involve processing that utilizes various set theory techniques known in the art of mathematics, such as the Dempster-Shafer theory.

In a preferred embodiment, the weighted classification determination subsystem 330 includes groups 714 representative of every possible combination of classes 716. For example, where the list of all potential classes 716 includes that of {an adult, a child, and a rear-facing infant seat (RFIS)}, the list of all possible groups 714 for these classes 716 will include: [{empty set}, {adult}, {child}, {RFIS}, {adult, child}, {adult, RFIS}, {child, RFIS}, {adult, child, RFIS}]. The empty set represents total ignorance for making a classification decision. This list of all possible groups 714 can be referred to as a power set. The power set includes all of the possible classifications 220 from which the system 100 can select a current classification 220. The system 100 should be configured to select the group 714 that has the highest probability of being the correct classification for the target information 218.

D. Classification Heuristics

A classification heuristic 718 (which can also be referred to as a classifier heuristics 718) is any process, algorithm, or set of instructions that can be implemented by the weighted classification determination subsystem 330 to generate the classification 220 from the various inputs. The classification heuristic 718 may account for probabilities and uncertainties by implementing evidential reasoning techniques or heuristics, such as the Dempster-Shafer theory of evidence. The following patent applications, which are hereby incorporated by reference in their entirety, disclose examples of different classification techniques that can be employed by the classification heuristic 718: “A RULES-BASED OCCUPANT CLASSIFICATION SYSTEM FOR AIRBAG DEPLOYMENT,” Ser. No. 09/870,151, filed on May 30, 2001; “OCCUPANT LABELING FOR AIRBAG-RELATED APPLICATIONS,” Ser. No. 10/269,308, filed on Oct. 11, 2002; “SYSTEM OR METHOD FOR SELECTING CLASSIFIER ATTRIBUTE TYPES,” Ser. No. 10/375,946, filed on Feb. 28, 2003; “SYSTEM AND METHOD FOR CONFIGURING AN IMAGING TOOL,” Ser. No. 10/457,625, filed on Jun. 9, 2003; “SYSTEM OR METHOD FOR CLASSIFYING IMAGES,” and Ser. No. 10/625,208, filed on Jul. 23, 2003. Further, the classification heuristic 718 can implement other evidential reasoning techniques without departing from the spirit and scope of the present methods and systems.

The weighted classification determination subsystem 330 may incorporate multiple different classification heuristics 718 in a weighted fashion. In a preferred embodiment, the classification heuristics 718 use mass or a basic probability assignment as a basic element of evidence. In this embodiment, the mass of an empty set is set to a value of zero, while the sum of the masses of all other possible sets (groups 714) equals a predefined value. The various classification heuristics 718 can be used in conjunction with various belief metrics 724, plausibility metrics 728, and context metrics 732 that will be discussed below.

E. Probability Metrics

Some of the classification heuristics 718 identified above generate one or more weighted probability metrics 720 as a means for quantifying the confidence associated with a particular potential classification 220. In particular, the probability metrics 720 may include confidence factors for the potential group 714 from which the classification 220 will be selected. In a preferred embodiment of the weighted classification determination subsystem 330, probability metrics 720 are influenced by belief metrics 724, plausibility metrics 728, context metrics 732, event flags 732, and historical attributes 734, as discussed below.

F. Belief Heuristics

A belief heuristic 722 is a type of classification heuristic 718 that generates a belief metric 724, discussed below. The purpose of the belief heuristic 722 is to generate a measurement that relates to the aggregate “support” or evidence that exists for a particular group 714 being selected as the classification 220. The belief heuristic 722 can be applied to each potential classification 220 determination, resulting in each potential selection being associated with a belief metric 724. In other embodiments, the belief heuristic 722 may be limited to an initial classification 220 generated by another classification heuristic 718, a prior classification 220, or only a subset of the potential groups 714 available for the purposes of classification 220 determinations. In a preferred embodiment, the belief heuristic 722 incorporates the Dempster-Shafer rules of evidence combination.

G. Belief Metrics

A belief metric 724 is the output generated by the belief heuristic 722. The belief metric 724 is potentially any numerical value (or even a range of numerical values) that illustrates the “support” that exists for a potential classification 220.

The Dempster-Shafer theory can be used to generate the belief metric 724. In a preferred embodiment, an incoming probability mass metric is combined with the past probability mass metric for each group 714 of classes 716 according to Dempster's Rule of Combination depicted as Equation 1, in which ml represents a past probability mass metric, m2 represents an incoming probability mass metric of one of the possible subsets in the power set, and φ represents the empty set.

$$Equation 1 \text{:}$$

$$new\_mass ( A ) = \frac{{\sum }_{X ⋂ Y = A} m1 ( X ) * m2 ( Y )}{1 - {\sum }_{X ⋂ Y = ϕ} m1 ( X ) * m2 ( Y )}$$

Once the “new mass” is determined for each class 716, the belief metrics 724 and the plausibility metric 128 (discussed below) can be generated or updated. One example of a belief metric 724 is illustrated in Equation 2:

$$Belief ( A ) = {\sum }_{B ⊆ A} m ( B )$$

In Equation 2, B⊂A represents B is a subset of A, so the sum is over all the elements of the power set B, where B is a subset of A.

In some embodiments of the weighted classification determination subsystem 330, the belief metric 724 is represented in the form of an interval (a “belief metric interval” or “belief interval”) that incorporates the value of the plausibility metric 728, e.g. Plausibility(A) discussed below, as well as the value of Belief(A) generated from Equation 2. Such an interval is represented in Equation 3:
Belief interval=[Belief(A), Plausibility(A)]

H. Plausibility Heuristics

Plausibility heuristics 726 represent the “flip side” of belief heuristics 722. Plausibility heuristics 726 generate one or more plausibility metrics 728 that represent, in a numerical fashion, the plausibility of a particular transition from one classification 220 to another classification 220. This type of processing can incorporate predefined likelihoods of particular transitions occurring. For example, in a safety restraint embodiment, it may be foreseeable for an adult to appear as a child for a period of time, but it would be less foreseeable for the transition from adult to RFIS to occur (recall this transition appears to occur when the occupant leans far forward in the seat). The plausibility heuristics 726 can incorporate such predefined presumptions and probabilities into the calculation or subsequent modification of the plausibility metrics 728. Each plausibility metric 728 preferably relates to a particular belief metric 724, with both the plausibility metric 728 and the belief metric 724 referring to a particular group 714.

I. Plausibility Metrics

A preferred embodiment of the weighted classification determination subsystem 330 applies the Dempster-Shafer rules of evidence combination, as illustrated in Equation 1, Equation 2, and Equation 3 above for the creation of belief metrics 724 and plausibility metrics 728. Equation 4 and Equation 5 provide as follows with regards to plausibility metrics 728.

$$Equation 4 \text{:}$$

$$Basic Probability Assignment ( A ) = m ( A )$$

$$Equation 5 \text{:}$$

$$Plausibility ( A ) = 1 - {\sum }_{B ⊆ {A}^{′}} m ( B )$$

where A′=compliment of A.

Thus, the plausibility metric 728 can be represented in the numerical value of the sum of all the evidence that does not directly refute the belief in A. Together, the plausibility metric 728 and belief metric 724 provide a desirable way to make classification determinations.

J. Context Heuristics

A context heuristic 730 is a process that can impact the classification 220 indirectly, by obtaining environmental or event-based information that allows the weighted classification determination subsystem 330 to make a smarter decision than the mathematical analysis of the plausibility heuristic 126, belief heuristic 122, and other classifier heuristics 118 could make on their own. For example, in a safety restraint embodiment, knowledge regarding the opening of a door, the presence or absence of a key in the ignition, the presence or absence of a running engine, and a litany of other considerations may add context to the classification process that can eliminate a variety of potential groups 714 and classes 716 from consideration as potential classifications 220. Context heuristics 730 can generate one or more context metrics 732 and/or result in the setting of various event flags 733. Context heuristics 730 are by definition, context specific, and thus different embodiments of the classification system 100 can include a wide variety of different context heuristics 730.

K. Context Metrics

A context metric 732 is the result that is generated or outputted by the context heuristic 730. Examples of context metrics 732 can include a numerical value representing the amount of light in the environment, the weight of the occupant 105, the speed of the vehicle, etc. The weighted classification determination subsystem 330 can use the context metrics 732 to influence classification 220 determinations.

L. Event Flags

An event flag 733 is similar to a context metric 732 in that both are outputs of the context heuristic 730. However, unlike the context metrics 732 that possess a potential wide range of numerical values, the event flags 733 are limited to binary values, such as the open/closed status of a door, the moving/non-moving status of a vehicle, etc. The application of context metrics 732 and events flags 733 are particularly important to the determination subsystem 330 when historical attributes 734 (past classifications 220) are used to help determine or interpret the present classification 220. Certain context information, such as the opening of a door in a safety restraint application, can result in a tremendously different treatment of historical information, as discussed below.

M. Historical Attributes

Historical attributes 734 can potentially be incorporated into current decision making processes to help the system 100 make smarter classification decisions. In the context of a safety restraint application embodiment, if past classifications 220 (or past initial classifications 325) indicate that the occupant 105 of a vehicle is an adult, then the system 100 can use the past classifications 220 (or the past initial classifications 325) to determine a level of certainty that should be given a single current sensor 115 reading that indicates that the occupant 105 is an RFIS. This allows the system 100 to prevent making erroneous classifications 220 in many instances.

In a preferred embodiment of the weighted classification determination subsystem 330, historical attributes 734 are continuously saved and deleted, such as on a rotating base through a history cache configured to store a predefined number of previous classifications 220 and/or previous initial classifications 325. The weighted classification determination subsystem 330 can then use the information in the history cache to influence a current classification decision.

Historical attributes 734 can include but are not limited to previous classifications 220, initial classifications 325, relative orientations 340, probability metrics 120, and other metrics relating to those classifications 220. Relative orientations 340 of the target information 218 can be incorporated into the historical attributes 734, as discussed below. Different applications can make use of different libraries of historical attributes 734.

N. Relative Orientation

Relative orientations 340 of the target information 218 can be used to determine appropriate levels of confidence that should be given to particular instances of target information 218. In the context of a vehicle safety restraint application, the weighted classification determination subsystem 330 can adjust the reliability of a current classification 220 (or an initial classification 325) based on the relative orientation 340 of the occupant 105. When the relative orientation 340 of the occupant 105 is unfavorable such that the classification 220 of the occupant 105 is uncertain, the weighted classification determination subsystem 330 may reduce the confidence associated with the classification 220. In a preferred embodiment, the weighted classification determination subsystem 330 reduces the confidence of a classification 220 when the relative orientation 340 of the occupant 105 is generally forward-leaning or generally backward-reclining orientation.

The farther the occupant 105 is leaning in either direction, the more the weighted classification determination subsystem 330 will reduce the confidence in the associated classification 220. For example, when the occupant 105 is positioned generally upright, the classification 220 of the occupant 105 will be highly reliable, and the determination subsystem 330 may not degrade the confidence of the classification 220. When the occupant 105 is leaning generally forward, there is a poorer likelihood of a correct classification 220. The likelihood becomes increasingly poorer as the occupant 105 leans farther forward. At a forward-most position, the weighted classification determination subsystem 330 may determine that the occupant 105 has a zero probability of correct classification 220. Similarly, the likelihood of a correct classification 220 steadily decreases as the relative orientation 340 of the occupant 105 reclines rearward.

The relative orientations 340 can be incorporated into the historical attributes 734 of previous classifications 220 and used to affect a current classification decision. In a preferred embodiment, the likelihood of correct classification 220 based on the relative orientation 340 is integrated into a classification determination by factoring the relative orientation 340 into the plausibility heuristics 726. In particular, based on the relative orientation 340 of the occupant 105, the determination subsystem 330 can replace the new probability mass of the classification decision with the product of the new classification probability mass and the correct classification likelihood as a function of relative orientation 340 according to Equation 6:
Weighted new mass=New mass*Likelihood of Correct Classification(Position)

The weighted new probability mass represents the likelihood as a function of relative orientation 340 that the classification 220 is plausible given the relative orientation 340 provided by the dynamic tracker 320. As the likelihood of the correct classification reduces, the mass probability for that classification 220 also reduces, and the input to the history cache becomes increasingly one of ignorance. In a preferred embodiment, the system 100 reduces the likelihood of correct classification when the relative orientation 340 falls within a zone of unreliability (forward-pitch zone or rearward-pitch zone). Further, as an extent of the relative orientation 340 increases, a value by which the likelihood of correct classification is reduced also increases because more angled relative orientations 340 become less reliable for making classification decisions.

When a classification 220 is input into the history cache, the classification 220 has been weighted according to the likelihood of a correct classification, which is defined as a function of relative orientation 340 of the occupant 105. The determination subsystem 330 can use the weighted history attributes 734 in the history cache to influence the classification 220. In a preferred embodiment, the metrics of the history attributes 734 are averaged for the last predefined number of entries in the history cache. The average between these values is then computed for each group 714 in the power set. The current classification 220 that is output to the safety restraint application 145 should be the group 714 with the highest resultant probability of being correct.

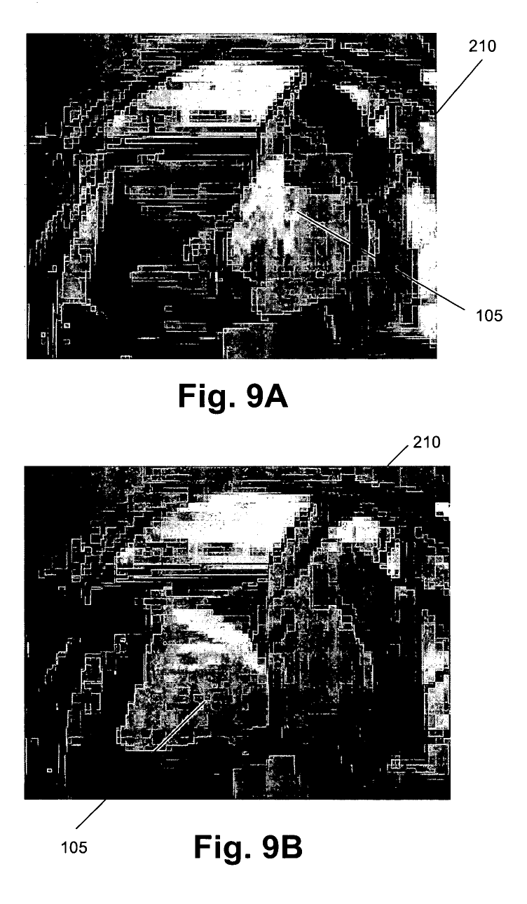

By using the relative orientation 340 of the occupant 105 to determine a likelihood of correct classification 220, the determination subsystem 330 is able to accurately determine classifications 220, as well as an appropriate confidence that should be given historical classifications 220. This is especially helpful in certain instances of occupant 105 motion within the vehicle. For example, FIGS. 9A-B show an adult occupant 105 at a generally upright and a forward-leaning position, respectively. At the forward-leaning position shown in FIG. 9B, the adult occupant 105 may look like a rear-facing infant seat (RFIS) to the sensor 115. However, the weighted classification determination subsystem 330 is able to avoid incorrectly classifying the occupant 105 as an RFIS by integrating the relative orientation 340 of the occupant 105 into the history attributes 734. The level of confidence for this particular classification 220 is degraded because the occupant 105 is at a position that is unreliable for making an accurate classification 220. Thus, the weighted classification determination subsystem 330 can attach an appropriate level of confidence to each classification 220. Further, historical attributes 734 are given appropriate levels of confidence because the classifications 220 in the history cache are each weighted by some level of ignorance dependent on their relative orientations 340.

If the relative orientation 340 is such that no confidence should be attached to its classification 220 (e.g., the occupant 105 is leaning too far forward), the weighted classification determination subsystem 330 can input ignorance into the classification heuristics 718. In a preferred embodiment, when ignorance is input into the classification heuristics 718, old classification 220 values are maintained with slight reductions in their confidence levels.

V. Process Flow of a Safety Restraint Embodiment

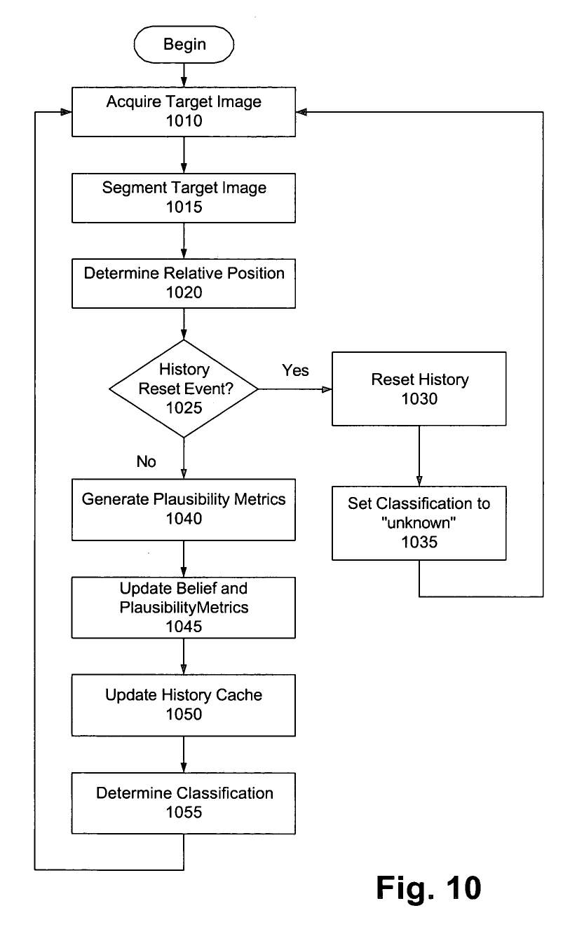

FIG. 10 is a flow diagram illustrating an example of operation of an exemplary classification system 100 in a vehicle safety restraint application embodiment. At 1010, the system 100 acquires the target image 210. Step 1010 can comprise the sensor 115 acquiring the target image 210. At 1015, the system 100 segments the target image 210 to isolate target information 218. At 1020, the system 100 determines the relative orientation 340 of the target information 218. This can be done in any of the ways discussed above.

At 1025, the system 100 determines whether a history reset event has occurred. A history reset event can include any combination of context metrics 732 or event flags 733 being set. The opening of a door is an example of an event that can be detected, and result in the setting of an event flag 733 as discussed above. Different vehicle safety restraint applications may include different types of event flags 733. Similarly, non-safety restraint and non-vehicle applications can also include a wide variety of different events for the purpose identifying various contextual and environmental factors that are relevant to making accurate classifications 220. Alternative embodiments of the system 100 may check for a number or combination of different or additional events at 1025. For example, the system 100 may check whether the vehicle is stopped.

In some embodiments of the system 100, the sensor 115 providing the target image 210 to the system 100 is not the same device that detects the occurrence of the event, or results in the setting of the event flag 733. For example, a mechanism within the door could be used to determine whether or not the door is open, while a video camera could be used to capture the target image 210 used by the system 100 to generate classifications 220. In other embodiments, the same sensor 115 used to capture target images 210, is also used to identify the occurrence of history reset events. For example, an image 210 of the interior of the vehicle could potentially be used to determine whether or not the door is currently open.

If the system 100 at 1025 determines that a history reset event has occurred, the system 100 can reset history information at 1030. This is appropriate because an event flag may indicate a change of passengers (e.g., with an opening of a door), and thus the system 100 should no longer rely on past data. In alternative embodiments, the system 100 may refrain from actually deleting the history information and instead simply sharply discount the history information to take into consideration the high likelihood that the occupant of the seat has changed. If historical information is to be removed, a history cache component of the processor can be flushed or deleted.

With the deleting of history information at 1030, the classification 220 at 1035 is temporarily set to the “unknown” or “all” group, the group 714 that includes all of the classes 716. In an embodiment where all history is not deleted at 1030, it may still be useful to temporarily set the classification 220 at 1035 to “unknown” or “all” because it will force the system 100 to take a fresh look at the target information 218 captured after the door opening event. In a preferred embodiment, setting the classification 220 to “unknown” at 1035 includes setting the belief metric 724 associated with the classification 220 to ignorance. After the classification 220 is set at 1035 in accordance with a “reset history event”, the system 100 receives new sensor readings at 1010 and the processing loop begins once again.

If a reset history event has not occurred at 1025, then the system 100 invokes one or more plausibility heuristics 726 to generate at 1040 one or more plausibility metrics 128 for each group 714 being considered, as discussed above. In a preferred embodiment, Equation 4, Equation 5, and Equation 6, as illustrated above, are used to generate the plausibility metric 728. Equation 6 functions to incorporate the relative orientation 340 of the vehicle occupant 105 into the plausibility metric 728 by multiplying the probability mass by the likelihood that a classification 220 is correct as a function of relative orientation 340. This position-based function can be configured to degrade the new probability mass appropriately given the relative orientation 340. For example, if the relative orientation 340 indicates a completely unreliable position, then the likelihood of correct classification can be set to zero so that the new mass is set to ignorance.

The plausibility heuristic 726 is used to determine the plausibility of changes between classifications 220. Plausibility heuristics 726 can be configured to preclude certain transitions, merely impede other transitions, while freely allowing still other potential transitions. Thus, the configuration of plausibility heuristics 726 are highly dependent upon the particular group/class configuration 712 incorporated into the processing performed by the system 100. For example, a large child or small adult may transition back and forth between the classifications 220 of child and adult with some regularity depending on their seating posture. Therefore, the plausibility heuristics 726 should be configured to freely permit such transitions. In contrast, it is highly unlikely that an adult will transition to a RFIS, unless the adult has leaned far forward. Thus, the system 100 should be at least somewhat skeptical of such a transition, particularly when coupled with supporting information from the tracker that the adult occupant 105 has indeed leaned forward.

The most recent classification 220 can be applied to a Dempster-Shafer combiner, and the plausibility metrics 728 for the classification 220 are compared to the plausibility metrics 728 of prior classifications 220. If the sum of the absolute differences in plausibility over all of the groups 714 exceeds a threshold value, then the incoming data is deemed implausible. The plausibility threshold value is preferably predefined, but it can in some embodiments, be set dynamically based on the prior performance of the system 100. By comparing the plausibility metric 728 with the plausibility threshold value, beliefs (as measured in the belief metric 724) in the classification 110 are slowly reduced. Over time, if the incoming classifications 220 are deemed implausible, the belief or confidence in whatever the previous classification 220 is also becomes less certain, which is a desirable impact. At some point, the belief metric 724 for any classification 220 may become so low that the new incoming classification 220 is considered plausible due to the lack of any strong beliefs about the past classifications 220. In this case, the system 100 can set the current classification 220 to “unknown.” This feature specifically allows the system 100 to recover from incorrect initial classification estimates. For example, the system 100 can recover from a situation in which an adult occupant 105 enters a vehicle and immediately leans forward for to pick up something or to tie a shoelace, and the system 100 incorrectly classifies the occupant 105 as a RFIS.

At 1045, the belief metric 724 and plausibility metric 728 for each group 714 under consideration is updated. In a preferred embodiment, the belief metrics 724 and plausibility metrics 728 are updated using the Dempster-Shafer rules relating to evidence combination. Those rules can be embodied in Equations 1-6, as illustrated above.

In a preferred embodiment, the value of the belief interval, which includes both the belief metric 724 and the plausibility metric 728 measures the true belief in the current classification 220 in the eyes of the system 100. The use of an interval differs from traditional Bayesian probability techniques, which would result in a single value. The meaning of the belief metric 724 is the sum of all the evidence that directly supports the decision A or classification A, as illustrated in Equations 1-6. Similarly, the plausibility metric 728 represents the sum of all the evidence that does not directly refute the belief that group A is the appropriate classification 220.

In a preferred embodiment, the system 100 adds some level of probability mass to the complete ignorance group 716 for each classification decision. This prevents a particular belief metric 724 from converging to an absolute belief value over time, and the system 100 maintains its capability to change or degrade a belief metric 728 based on a contradictory belief metric 728. After adding probability mass to the ignorance group 714, the system 100 renormalizes the sum of all probability masses of the groups 714 under consideration to a predefined value. Then the system 100 performs the Dempster-Shafer rules relating to evidence combination.

At 1050, the history cache is updated in light of the processing at 1045. Once the new belief metrics 724 and plausibility metrics 728 are computed for each group 714, they are preferably stored in a first-in-first-out buffer of historical attributes 734. The buffer is preferably maintained to hold between 5 and 10 historical “rounds” or “samples” of classifications 110 and/or relative orientations 340 with their accompanying metrics such as belief and plausibility (contextual information can also be stored if desired). As new information is captured and stored, the oldest “round” or “sample can then be deleted. The “rolling” buffer of historical attributes 734 provides an additional smoothing function to the system 100 by enabling the use of historical context to make classification decisions.

At 1055, the system 100 generates a latest determination of the appropriate classification 220 for the target information 218. The system 100 invokes one or more classification heuristics 718 for generating the updated classification 220. The classification heuristic 718 preferably incorporates the belief metric 724, the plausibility metric 728, other metrics, and the relative orientation 340 within the stored historical attributes 734 (residing in a history cache for the computer 130) for each of the groups 714 in the group/class configuration 712.

There are a number of ways to perform this, including but not limited to a simple averaging, a time-weighted averaging where the most recent data is the most heavily weighted, and a Kalman filter approach where the data is processed in a recursive approach that incorporates potentially all historical attributes 734 into the “final” classification 220. In a preferred embodiment, the classification 220 determination includes averaging values for belief metrics 724 and plausibility metrics 728 over all entries in the history cache. The average between these values is then computed for each group 714 in the power set. The output classification 220 can include the monitored group 714 where the average of the belief metric 724 and plausibility metric 728 are the highest.

In a preferred safety restraint embodiment of the system 100, the output classifications 220 can be one of the following groups 714: {RFIS}, {child}, {RFIS, child}, {adult}, or {empty}. This allows the system 100 to perform dynamic suppression based on the occupant's 105 proximity to the airbag for adults and children, and static suppression based solely on the classification 220 for the other classes 716 (i.e., the RFIS (including all infants) and the empty classes). It is also possible for some cases where the system 100 only disables a safety restraint for an RFIS and dynamically tracks any other type of occupant 105. The system 100 can use other groups 714 for various embodiments.

Some embodiments of the system 100 may be configured to only allow deployment of the safety restraint application when the occupant 105 is an adult. All other classes 716 and groups 714 disable the deployment of the safety restraint application. In this particular embodiment, the two monitored groups 714 would be {adult} and {RFIS, child, empty}.

The processing disclosed by FIG. 10 can be performed once in some embodiments of the system 100, but in a preferred embodiment, the processing repeats. For a safety restraint application, it is beneficial for the new classifications 220 to be generated repeatedly, with only a short period of time between the different classifications 220 and the different sensor readings.

VI. Process for Implementing a Classification System

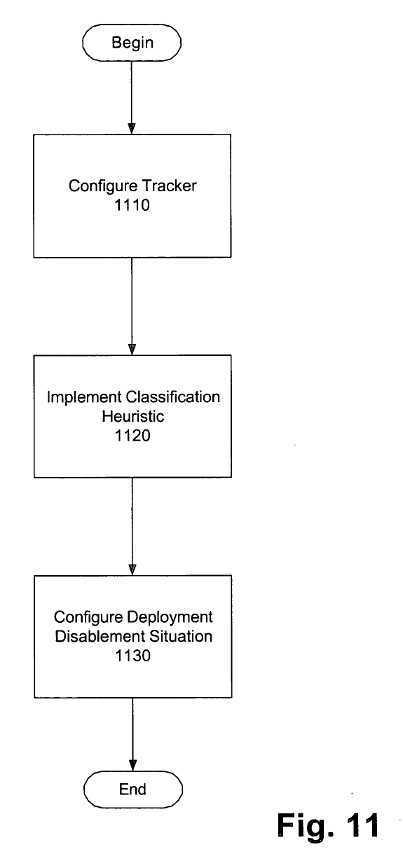

FIG. 11 is a flow diagram illustrating an exemplary process for implementing an occupant classifier 100 for use in the context of a vehicle safety restraint application.

At 1110, the tracker 320 is configured to use the target image 210 to identify the relative orientation 340 of the occupant 105 in relation to the predefined reference 540. The tracker 320 can be configured to identify the relative orientation 340 in any of the ways discussed above, including using an ellipse-fitting process to define the occupant 105.

At 1120, the classification heuristic 718 is implemented to classify the occupant 105 based on historical classification attributes 734 that are configured to be influenced by the relative orientation 340 and the initial classification 325. The classification heuristic 718 can be implemented for processing by the computer 130. The relative positions 340, initial classifications 325, and historical attributes 734 can be factored into the classification heuristics 718 in any of the ways discussed above.

At 1130, a deployment disablement situation is configured. The disablement situation should be configured to preclude deployment of a safety restraint device when the weighted classification 220 indicates a predefined disablement situation, such as a particular classification 220 of the occupant 105. For example, a particular group 714 (e.g., {RFIS}) can be defined as a disablement situation. When the weighted classification 220 is that particular group 714, the vehicle safety restraint application can be configured to preclude deployment of the safety restraint device. In different embodiments, different groups 714 can be defined as disablement situations.

### VII. ALTERNATIVE EMBODIMENTS

While the invention has been specifically described in connection with certain specific embodiments thereof, it is to be understood that this is by way of illustration and not of limitation, and the scope of the appended claims should be construed as broadly as the prior art will permit. Given the disclosure above, one skilled in the art could implement the system 100 in a wide variety of different embodiments, including vehicle safety restraint applications, security applications, radiological applications, navigation applications, and a wide variety of different contexts, purposes, and environments.

What is claimed is:

1. A method of using a visual image acquired by a sensor to classify a vehicle occupant in a vehicle safety restraint application, the method comprising:
generating an initial classification of the vehicle occupant;
identifying a relative orientation of the vehicle occupant in relation to a predefined reference; and
generating a weighted classification of the vehicle occupant based on said initial classification and said relative orientation.

2. The method of claim 1, wherein said relative orientation is identified by fitting an ellipse to the vehicle occupant.

3. The method of claim 2, wherein said relative orientation is identified by an angular pitch of said ellipse in relation to said predefined reference.

4. The method of claim 1, wherein said predefined reference includes a generally vertical axis representative of a generally upright orientation of the vehicle occupant.

5. The method of claim 1, further comprising categorizing said relative orientation as being within one of a generally upright zone, a generally forward-pitch zone, and a generally rearward-pitch zone.

6. The method of claim 1, wherein said generating of said weighted classification includes using an evidential reasoning heuristic, said relative orientation being factored into said evidential reasoning heuristic to generate said weighted classification.

7. The method of claim 6, wherein said evidential reasoning heuristic is configured for determining a weighted probability of said initial classification based on said relative orientation.

8. The method of claim 7, wherein said weighted probability is defined as a product of an initial probability and a likelihood of correct classification, said likelihood of correct classification being a function of said relative orientation.

9. The method of claim 8, further comprising reducing said likelihood of correct classification when said relative orientation is determined to be within one of a predefined forward-pitch zone and a predefined rearward-pitch zone.

10. The method of claim 9, wherein an extent of said relative orientation influences a value by which said likelihood of correct classification is reduced.

11. The method of claim 7, further comprising setting said weighted probability to ignorance when said relative orientation is forward-leaning by at least approximately a predetermined threshold.

12. The method of claim 6, wherein said evidential reasoning heuristic includes averaging historical classification attributes to generate said weighted classification, and wherein said relative orientation is incorporated into said historical classification attributes.

13. The method of claim 12, wherein said historical classification attributes include probability metrics that are configured to be influenced by said relative orientation.

14. The method of claim 1, further comprising providing said weighted classification to the vehicle safety restraint application.

15. A method of implementing an occupant classifier for use in a vehicle safety restraint application, comprising:
configuring a tracker to use a visual image to identify a relative orientation of a vehicle occupant in relation to a predefined reference;
implementing a weighted classification heuristic configured to generate a weighted classification of the vehicle occupant based on historical classification attributes that are configured to be influenced by said relative orientation and an initial classification of the vehicle occupant;
defining a group as a disablement decision; and
configuring the vehicle safety restraint application to preclude deployment of a safety restraint device when said weighted classification indicates that the vehicle occupant is classified as said group.

16. The method of claim 15, further comprising:
defining a zone of unreliability;
implementing a plausibility metric in said historical classification attributes, wherein said plausibility metric is configured to be reduced when said relative orientation falls within said zone of unreliability.

17. The method of claim 16, further comprising configuring said plausibility metric to be reduced by a value that corresponds with an extent of said relative orientation.

18. A system for classifying target information of a visual image acquired with a sensor, comprising:
an initial classification determination subsystem for generating an initial classification of the target information;
a tracking subsystem for identifying a relative orientation of the target information in relation to a predefined reference; and
a weighted classification determination subsystem for generating a weighted classification of the target information based on said initial classification and said relative orientation.

19. The system of claim 18, wherein said tracking subsystem includes an ellipse defined and fitted to the target information to identify said relative orientation.

20. The system of claim 19, wherein said tracking subsystem includes an angular pitch of said ellipse in relation to said predefined reference, said angular pitch being indicative of said relative orientation.

21. The system of claim 18, wherein said predefined reference includes a generally vertical axis.

22. The system of claim 18, wherein said tracking subsystem includes a generally upright zone, a generally forward-pitch zone, and a generally rearward-pitch zone, said tracking subsystem being configured to categorize said relative orientation as being within one of said generally upright zone, said generally forward-pitch zone, and said generally rearward-pitch zone.

23. The system of claim 18, wherein said weighted classification determination subsystem includes an evidential reasoning heuristic configured to factor in said relative orientation to generate said weighted classification.

24. The system of claim 23, wherein said evidential reasoning heuristic includes a weighted probability of said initial classification based on said relative orientation.

25. The system of claim 24, wherein said weighted probability comprises a product of an initial probability and a likelihood of correct classification, said likelihood of correct classification being a function of said relative orientation.

26. The system of claim 25, wherein said tracking subsystem includes a predefined forward-pitch zone and a predefined rearward-pitch zone, and said weighted classification determination subsystem is configured to reduce said likelihood of correct classification when said relative orientation is determined to be within one of said predefined forward-pitch zone and said predefined rearward-pitch zone.

27. The system of claim 26, wherein said weighted classification determination subsystem includes an extent of said relative orientation, said extent being configured to influence a value by which said likelihood of correct classification is reduced.

28. The system of claim 18, wherein said weighted classification determination subsystem includes historical classification attributes configured to be averaged by said weighted classification determination subsystem to generate said weighted classification, wherein said relative orientation is incorporated in said historical classification attributes.

29. The system of claim 28, wherein said historical classification attributes include probability metrics that are configured to be influenced by said relative orientation.

30. A system for classifying a vehicle occupant in a vehicle safety restraint application, comprising:
a sensor configured to acquire a target image representative of the vehicle occupant in the vehicle safety restraint application;
a computer configured to:
generate an initial classification of said target image;
track said target image to identify a relative orientation of the vehicle occupant in relation to a predefined reference;
generate a weighted classification of the vehicle occupant using an evidential reasoning heuristic, wherein said weighted classification is based on said initial classification and said relative orientation; and
provide the vehicle safety restraint application with said weighted classification.

31. The system of claim 30, wherein said computer is configured to identify said relative orientation by fitting an ellipse to the vehicle occupant.

32. The system of claim 31, wherein said computer is configured to indicates said relative orientation as an angular pitch of said ellipse in relation to said predefined reference.

33. The system of claim 30, wherein said predefined reference includes a generally vertical axis representative of a generally upright orientation of the vehicle occupant.

34. The system of claim 30, wherein said computer is configured to categorize said relative orientation as being within one of a generally upright zone, a generally forward-pitch zone, and a generally rearward-pitch zone.

35. The system of claim 30, wherein said evidential reasoning heuristic is configured to factor in said relative orientation to generate said weighted classification.

36. The system of claim 35, wherein said computer is configured to determine a weighted probability of said initial classification based on said relative orientation.

37. The system of claim 36, wherein said computer is configured to define said weighted probability as a product of an initial probability and a likelihood of correct classification, said likelihood of correct classification being a function of said relative orientation.

38. The system of claim 37, wherein said computer is configured to reduce said likelihood of correct classification when said relative orientation is determined to be within one of a predefined forward-pitch zone and a predefined rearward-pitch zone.

39. The system of claim 38, wherein said computer is configured to determine an extent of said relative orientation and use said extend to influence a value by which said likelihood of correct classification is reduced.

40. The system of claim 35, wherein said evidential reasoning heuristic includes historical classification attributes for averaging to generate said weighted classification, and wherein said relative orientation is incorporated into said historical classification attributes.

41. The system of claim 40, wherein said historical classification attributes include probability metrics that are configured to be influenced by said relative orientation.
